(19) United States
(12) Patent Application Publication
(10) Pub. No.: US 2025/0392525 A1
(43) Pub. Date: Dec. 25, 2025

(54) COMMUNICATION METHOD AND COMMUNICATION DEVICE

(71) Applicant: GUANGDONG OPPO MOBILE TELECOMMUNICATIONS CORP., LTD., Dongguan (CN)

(72) Inventor: Dexin LI, Dongguan (CN)

(73) Assignee: GUANGDONG OPPO MOBILE TELECOMMUNICATIONS CORP., LTD., Dongguan (CN)

(21) Appl. No.: 19/253,000

(22) Filed: Jun. 27, 2025

Related U.S. Application Data
(63) Continuation of application No. PCT/CN2022/142910, filed on Dec. 28, 2022.

(51) Int. Cl. H04L 41/16; H04B 7/06; H04W 8/22

(52) U.S. Cl. CPC H04L 41/16; H04B 7/0626; H04B 7/0696; H04W 8/22

(57) ABSTRACT

Provided are a communication method and a communication device. The method comprises: a first communication device receiving first indication information; and on the basis of the first indication information, the first communication device performing online training on a first model used for communication, wherein the first indication information is used for indicating an online training policy for the first model, and the online training policy, which is indicated by means of the first indication information, can be used for indicating how an online training process is performed.

### CROSS-REFERENCE TO RELATED APPLICATIONS

This application is a continuation of International Application No. PCT/CN2022/142910, filed on Dec. 28, 2022, the disclosure of which is hereby incorporated by reference in its entirety.

### TECHNICAL FIELD

This application relates to the field of communications technologies, and more specifically, to a method for communication and a communications device.

### BACKGROUND

In the communications field, attempts are being made to resolve, by using an artificial intelligence method, a technical problem that is difficult to resolve by using a conventional communication method. An artificial intelligence model may be trained through online training. A training sample for online training may be from a real communications system. Therefore, performing online training on a model used for communication may improve generalization of the model. However, current discussions on online learning solutions mainly focus on frameworks and overall processes.

### SUMMARY

This application provides a method for communication and a communications device. The following describes the aspects related to this application.

According to a first aspect, there is provided a method for training a model. The method includes: receiving, by a first communications device, first indication information; performing, by the first communications device based on the first indication information, online training on a first model used for communication, where the first indication information is used to indicate an online training strategy for the first model.

According to a second aspect, there is provided a method for communication. The method includes: transmitting, by a second communications device, first indication information to a first communications device, where the first indication information is used to indicate an online training strategy for an artificial intelligence first model used for communication, and the first model is trained online based on the first indication information.

According to a third aspect, there is provided a communications device. The communications device is a first communications device, and the communications device includes: a receiving unit, configured to receive first indication information, where the first communications device performs, based on the first indication information, online training on a first model used for communication, where the first indication information is used to indicate an online training strategy for the first model.

According to a fourth aspect, there is provided a communications device. The communications device is a second communications device, and the communications device includes: a transmitting unit, configured to transmit first indication information to a first communications device, where the first indication information is used to indicate an online training strategy for an artificial intelligence first model used for communication, and the first model is trained online based on the first indication information.

According to a fifth aspect, there is provided a communications device. The communications device includes a processor and a memory. The memory is configured to store one or more computer programs, and the processor is configured to invoke the computer program in the memory to cause the communications device to perform some or all of the steps of the method according to the first aspect and/or the second aspect.

According to a sixth aspect, there is provided a communications device. The communications device includes a processor, a memory, and a transceiver. The memory is configured to store one or more computer programs, and the processor is configured to invoke the computer program in the memory to cause the communications device to perform some or all of the steps in the method according to the first aspect and/or the second aspect.

According to a seventh aspect, an embodiment of this application provides a communications system, and the system includes the communications device described above. In another possible design, the system may further include another device that interacts with the communications device in the solution provided in this embodiment of this application.

According to an eighth aspect, an embodiment of this application provides a computer-readable storage medium. The computer-readable storage medium stores a computer program, and the computer program causes a communications device to perform some or all of the steps in the method according to the foregoing aspects.

According to a ninth aspect, an embodiment of this application provides a computer program product. The computer program product includes a non-transitory computer-readable storage medium storing a computer program, and the computer program is operable to cause a communications device to perform some or all of the steps of the method according to the foregoing aspects. In some implementations, the computer program product may be a software installation package.

According to a tenth aspect, an embodiment of this application provides a chip. The chip includes a memory and a processor. The processor may invoke a computer program from the memory and run the computer program, to implement some or all of the steps described in the method according to the foregoing aspects.

### BRIEF DESCRIPTION OF DRAWINGS

FIG. 1 is a schematic diagram of a wireless communications system to which embodiments of this application are applicable.

FIG. 2 is an example diagram of a neural network model.

FIG. 3 is an example diagram of a channel state information feedback system.

FIG. 4A and FIG. 4B are example diagrams of beam sweeping processes, respectively.

FIG. 5 is an example diagram of a working procedure of an online learning solution.

FIG. 6 is a schematic flowchart of a method for communication according to an embodiment of this application.

FIG. 7 is a schematic flowchart of another method for communication according to an embodiment of this application.

FIG. 8 is a schematic flowchart of another method for communication according to an embodiment of this application.

FIG. 9 is a schematic flowchart of another method for communication according to an embodiment of this application.

FIG. 10 is a schematic structural diagram of a communications device according to an embodiment of this application.

FIG. 11 is a schematic structural diagram of another communications device according to an embodiment of this application.

FIG. 12 is a schematic structural diagram of an apparatus for communication according to an embodiment of this application.

### DESCRIPTION OF EMBODIMENTS

The following describes the technical solutions in this application with reference to the accompanying drawings.

### Communications System

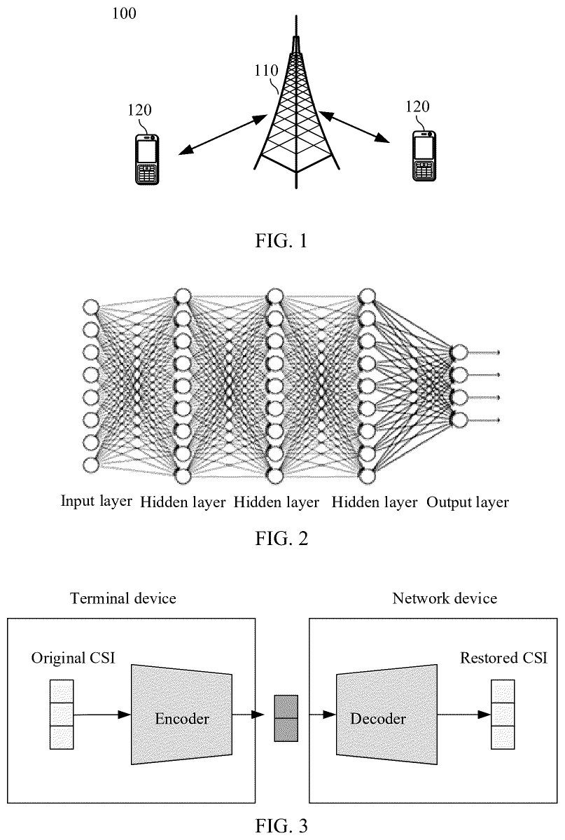

FIG. 1 shows a wireless communications system 100 to which embodiments of this application are applicable. The wireless communications system 100 may include a network device 110 and terminal devices 120. The network device 110 may be a device that communicates with the terminal device 120. The network device 110 may provide communication coverage for a specific geographic area, and may communicate with the terminal device 120 located within the coverage.

FIG. 1 exemplarily shows one network device and two terminals. Optionally, the wireless communications system 100 may include a plurality of network devices, and another quantity of terminal devices may be included in coverage of each network device, which is not limited in embodiments of this application.

Optionally, the wireless communications system 100 may further include another network entity such as a network controller or a mobility management entity, which is not limited in embodiments of this application.

It should be understood that the technical solutions of embodiments of this application may be applied to various communications systems, such as a 5th generation (5G) system or new radio (NR), a long-term evolution (LTE) system, an LTE frequency division duplex (FDD) system, and an LTE time division duplex (TDD) system. The technical solutions provided in this application may be further applied to a future communications system, such as a 6th generation mobile communications system or a satellite communications system.

The terminal device in embodiments of this application may also be referred to as user equipment (UE), an access terminal, a subscriber unit, a subscriber station, a mobile site, a mobile station (MS), a mobile terminal (MT), a remote station, a remote terminal, a mobile device, a user terminal, a terminal, a wireless communications device, a user agent, or a user apparatus. The terminal device in embodiments of this application may be a device providing a user with voice and/or data connectivity and capable of connecting people, objects, and machines, such as a handheld device or a vehicle-mounted device having a wireless connection function. The terminal device in embodiments of this application may be a mobile phone, a tablet computer (Pad), a notebook computer, a palmtop computer, a mobile internet device (MID), a wearable device, a virtual reality (VR) device, an augmented reality (AR) device, a wireless terminal in industrial control (industrial control), a wireless terminal in self driving, a wireless terminal in remote medical surgery, a wireless terminal in smart grid (smart grid), a wireless terminal in transportation safety, a wireless terminal in smart city, a wireless terminal in smart home, or the like. Optionally, the UE may be configured to function as a base station. For example, the UE may serve as a scheduling entity, which provides a sidelink signal between UEs in vehicle-to-everything (V2X), or device-to-device (D2D) communications, or the like. For example, a cellular phone and a vehicle communicate with each other by using a sidelink signal. A cellular phone and a smart home device communicate with each other, without relaying a communication signal by using a base station.

The network device in embodiments of this application may be a device configured to communicate with the terminal device. The network device may also be referred to as an access network device or a radio access network device. For example, the network device may be a base station. The network device in embodiments of this application may be a radio access network (RAN) node (or device) that connects the terminal device to a wireless network. The base station may broadly cover the following various names, or may be interchanged with the following names, such as a NodeB, an evolved NodeB (eNB), a next generation NodeB (gNB), a relay station, an access point, a transmitting and receiving point (TRP), a transmitting point (TP), a master eNodeB (master eNB, MeNB), a secondary eNodeB (secondary eNB, SeNB), a multi-standard radio (MSR) node, a home base station, a network controller, an access node, a radio node, an access point (AP), a transmission node, a transceiver node, a baseband unit (BBU), a remote radio unit (RRU), an active antenna unit (AAU), a remote radio head (RRH), a central unit (CU), a distributed unit (DU), a positioning node, and the like. The base station may be a macro base station, a micro base station, a relay node, a donor node, or the like, or a combination thereof. Alternatively, the base station may be a communications module, a modem, or a chip disposed in the device or apparatus described above. Alternatively, the base station may be a mobile switching center, a device that assumes the function of a base station in D2D, V2X, and machine-to-machine (M2M) communications, a network-side device in a 6G network, a device that assumes the function of a base station in a future communications system, or the like. The base station may support networks of a same access technology or different access technologies. A specific technology and a specific device form used by the network device are not limited in embodiments of this application.

The base station may be stationary or mobile. For example, a helicopter or an unmanned aerial vehicle may be configured to function as a mobile base station, and one or more cells may move depending on a location of the mobile base station. In other examples, a helicopter or an unmanned aerial vehicle may be configured to function as a device in communication with another base station.

In some deployments, the network device in embodiments of this application may be a CU or a DU, or the network device includes a CU and a DU. The gNB may further include an AAU.

The network device and the terminal device may be deployed on land, including being indoors or outdoors, handheld, or vehicle-mounted, may be deployed on a water surface, or may be deployed on a plane, a balloon, or a satellite in the air. In embodiments of this application, a scenario in which the network device and the terminal device are located is not limited.

It should be understood that all or some of functions of the communications device in this application may alternatively be implemented by software functions running on hardware, or by virtualization functions instantiated on a platform (for example, a cloud platform).

### Artificial Intelligence

In recent years, artificial intelligence (AI) research represented by neural networks (NN) has made great achievements in many fields, and will also play an important role in people's production and life for a long time in the future. In particular, as an important research direction of the AI technology, machine learning (ML) successfully resolves, by using a non-linear processing capability of neural networks, a series of problems that were difficult to handle. The AI technology has even shown stronger performance than humans in fields such as image recognition, voice processing, natural language processing, and games, thus receiving increasing attention.

In the AI technology, a common model is a neural network model. A neural network is non-linear and data-driven. The neural network may be designed to have more layers. FIG. 2 is an example diagram of a neural network model. As shown in FIG. 2, the neural network of a plurality of layers is trained layer by layer for feature learning, thus greatly enhancing learning and processing capabilities of the neural network. Therefore, the neural network model is widely applied in aspects such as pattern recognition, signal processing, optimization combination, and anomaly detection.

Since the AI technology, especially deep learning, has achieved great success in computer vision, natural language processing, and the like, deep learning has begun to be used to resolve a technical problem in the communications field that is difficult to resolve by using a conventional communication method. For example, the AI technology may be applied in many aspects such as modeling or learning in a complex and unknown environment, channel prediction, intelligent signal generation and processing, network status tracking and intelligent scheduling, and network optimization and deployment. The AI technology is expected to promote evolution of communication paradigms and changes of network architectures in the future, which is of great significance and value to research on 6G technologies.

The following describes a combination of AI and communication by using application of an AI model in channel state feedback and beam management in the communications field as an example.

### Channel State Information (CSI) Feedback Based on an AI Model

A terminal device may extract features from actual channel matrix data by using an AI model, and a network device may restore, as much as possible, channel matrix information compressed and fed back by the terminal device. In view of this, the AI model may offer a possibility of reducing CSI feedback overheads for the terminal device while restoring the channel information.

CSI feedback based on an AI model is described by using an example in which the AI model is a deep learning auto-encoder. In CSI feedback based on deep learning, channel information may be considered as a to-be-compressed image, the channel information may be compressed and fed back by using the deep learning auto-encoder, and a compressed channel image may be reconstructed at a transmitting end. Therefore, the channel information may be retained to a greater extent.

FIG. 3 is an example diagram of a channel state information feedback system. The feedback system shown in FIG. 3 is implemented based on an auto-encoder structure. Auto-encoders are classified into an encoder and a decoder. The encoder and the decoder are deployed at a transmitting end and a receiving end, respectively. After obtaining original CSI through channel estimation, the transmitting end compresses and encodes a channel information matrix by using a neural network of the encoder, and feeds back a compressed bit stream to the receiving end via an air interface feedback link. The receiving end restores the channel information based on the fed-back bit stream by using the decoder, to obtain complete fed-back channel information or restored CSI (reconstructed CSI). It should be noted that network model structures in the encoder and the decoder shown in FIG. 3 may be flexibly designed.

### Beam Management Based on an AI Model

In some communication protocols (for example, a first version of an NR system, that is, R15), communication in a millimeter-wave frequency band is introduced, and a corresponding beam management mechanism is also introduced. Briefly, beam management may be classified into uplink beam management and downlink beam management. The following description is mainly provided by using a downlink beam management mechanism as an example. The downlink beam management mechanism includes processes such as downlink beam sweeping, beam reporting, and indication of a downlink beam by a network device.

A downlink beam sweeping process may refer to that the network device performs transmit beam sweeping in different directions by using a downlink reference signal synchronization block (synchronization signal/PBCH block, SSB) and/or a channel state information measurement reference signal (CSI-RS). The terminal device may perform measurement by using different receive beams, so that all beam pair combinations may be traversed. In a measurement process, the terminal device may calculate an L1 reference signal received power (L1-RSRP) value of a beam pair. It should be noted that the L1-RSRP herein may also be replaced with another beam link indicator. For example, the another indicator may include L1 signal to interference plus noise ratio (L1-SINR), L1 reference signal received quality (L1-RSRQ), and the like. L1-SINR is already supported in some communication standards, and L1-RSRQ is not supported in some communication standards.

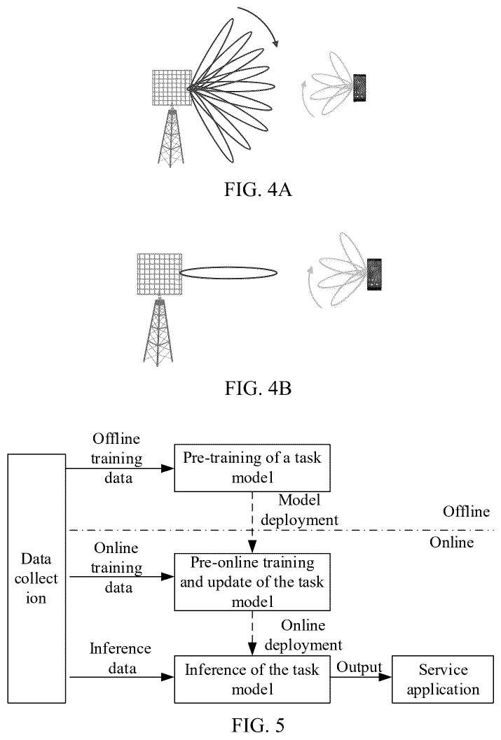

FIG. 4A and FIG. 4B are example diagrams of beam sweeping processes, respectively. FIG. 4A shows a process of traversing transmit beams and receive beams. FIG. 4B shows a process of traversing receive beams for a specific transmit beam.

Beam reporting may also be referred to as optimal beam reporting. The terminal device may compare L1-RSRP values of all measured beam pairs, select K transmit beams having highest L1-RSRP, and report the K transmit beams as uplink control information to the network device. K may be a positive integer. After decoding a beam report from the terminal device, the network device may complete beam indication to the terminal device by using a transmission configuration indicator (TCI) state (including a transmit beam referenced by an SSB or CSI-RS) carried in medium access control control element (MAC CE) or downlink control information (DCI) signalling. The terminal device may perform reception by using a receive beam corresponding to the transmit beam.

In discussions of some communication standards (for example, R18), AI-based beam management is considered as one of main use cases for AI projects in these communication standards, and multiple rounds of use case selection and simulation hypothesis discussions have been conducted. Although there is currently no unanimous agreement on details in various aspects of how to implement better beam management based on AI, both spatial domain beam prediction and time domain prediction based on AI are considered as typical use cases. At present, a preliminary agreement has been reached on an implementation framework for AI-based beam management as follows: beam prediction is performed on a beam set A (set A) based on a measurement result of a beam set B (set B). The set B may be a subset of the set A. Alternatively, the set B and the set A may be different beam sets (for example, for the set A, narrow beams are used, while for the set B, wide beams are used). An AI model may be deployed on a network device or a terminal device. A measurement result of the set B may be L1-RSRP or other assistance information, such as a beam (beam pair) ID, or the like.

### Online Learning and Offline Learning

An AI network may create or train an AI model based on training data. Training the model is generally to generate a more accurate prediction result. Online learning and offline learning are methods for training a model in deep learning.

Offline learning may also be referred to as offline training. In an offline learning process, all training data may be obtained, and after the training data is randomly shuffled, the model is trained offline using the shuffled data in batches. For the offline learning method, the model may be used for prediction only after offline training of the model is completed.

Online learning may also be referred to as online training. In an online learning process, the model may be updated online using online streaming data. For example, according to the online learning method, the model may be adjusted or updated based on a single or a batch of data samples obtained in real time. According to the online learning method, data changes may be captured in a timely manner, thereby effectively improving update frequency of the model.

Currently, most simulation results are evaluated using simulated data, with very few evaluations conducted under a real-world system. The real-world system has a more complex environment, which poses a great challenge to generalization of the model. A wireless environment is not stable enough, and data distribution is inevitably affected by factors such as time, environment, and system policies. Therefore, distribution of data under the real-world system does not match exactly with distribution of data obtained offline. Performance of the AI model is strongly correlated with data distribution. If there is a significant difference between the data under the real-world system and the data obtained offline, it may lead to poor performance of the AI model pre-trained based on the data obtained offline. With the improvement of capabilities of terminal devices and network devices in the future, and with the advancement of more data under the real-world system, online learning solutions are increasingly discussed in the future, enabling the AI model to adapt to the real-world environment. However, current discussions on online learning solutions mainly focus on frameworks and overall processes. For example, deployment of offline pre-trained models and AI frameworks for online inference have been discussed in some communication protocols (such as R18).

FIG. 5 is an example diagram of a working procedure of an online learning solution. FIG. 5 is described below.

In an offline training phase, an offline device pre-trains a task model by using collected offline training data. After pre-training is completed, the task model may be deployed.

In an online training phase, an online device collects data from a real-world system as online training data. When online training data accumulates to reach a specific amount, the online device may perform online training once based on the deployed task model, to update the task model. The training continues until the model converges or another default training terminating condition is triggered. The updated task model may be deployed online and applied. Based on input inference data, the deployed task model may output a corresponding inference result, and output the inference result to a service application.

It may be learned that, a framework for online training is provided in a related technology, but no clear technical solution is provided for specific implementation of online training.

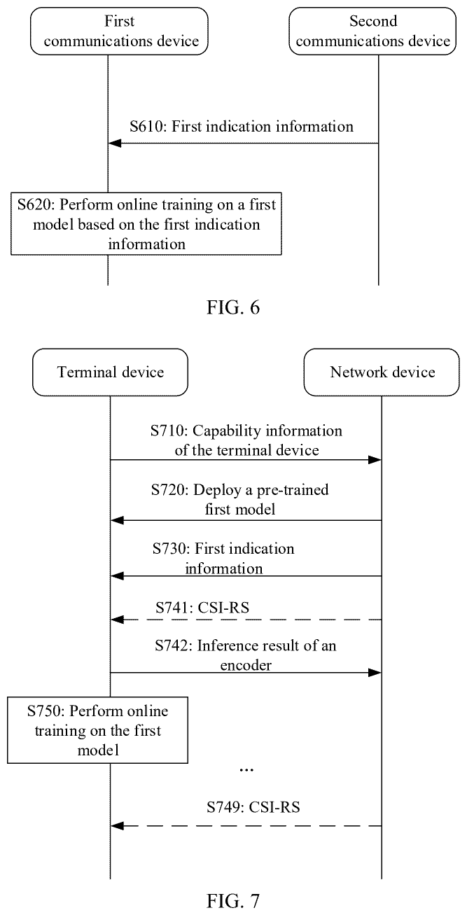

FIG. 6 is a schematic flowchart of a method for communication according to an embodiment of this application. The method shown in FIG. 6 may be performed by a first communications device and/or a second communications device. The first communications device and the second communications device may be devices that communicate with each other. For example, the first communications device may be a terminal device or a network device. Similarly, the second communications device may be a terminal device or a network device. In some embodiments, the first communications device may be referred to as an execution node, while the second communications device may be referred to as a control node. The first communications device may be deployed with a first model or may not be deployed with a first model. The first communications device may be, for example, a communications device that may obtain original training data.

The method shown in FIG. 6 may include steps S610 and S620.

In step S610, a first communications device receives first indication information. Accordingly, a second communications device transmits the first indication information.

The first indication information may be used to indicate an online training strategy for the first model. The first model may be a model used for communication. For example, the first model may include a channel state information feedback model and/or a beam management model. In some embodiments, the first model may be an AI model. For example, the first model may include a machine learning model. Alternatively, the first model may include a neural network model.

The online training strategy may be used to indicate how an online training process is performed. This application does not limit a method for indicating the online training strategy by using the first indication information. In some embodiments, the first indication information may be used to directly indicate the online training strategy for the first model. For example, the first indication information may include the online training strategy. In some embodiments, the first indication information may be used to indirectly indicate the online training strategy for the first model. The first indication information may include first information, and the first communications device may independently determine the online training strategy based on the first information. In other words, the first information may assist in implementing online training, or assist in determining the online training strategy. Therefore, in some embodiments, the first information is also referred to as an auxiliary online training strategy.

In step S620, the first communications device may perform online training on the first model based on the first indication information.

In a case in which the first model is deployed in a real communications system, online training may be performed on the first model. In an online training process, the first model may be updated, and training data for updating the first model is data from a real-world system.

As described above, the online training strategy indicated by using the first indication information may be used to indicate how an online training process is performed. Therefore, the first communications device may implement more flexible online training of the first model as instructed by using the first indication information. On the premise that online training of the first model has a real-time characteristic, adaptability of the first model to new data is improved. In addition, memory and computing resource overheads for an online training process are reduced. For example, in a case in which a communication environment is unstable, the first communications device may perform faster online update as instructed by using the first indication information, so as to ensure performance of the first model. Alternatively, in a case in which a communication environment is relatively stable, the first communications device may slow down update pace of online learning as instructed by using the first indication information, so that performance of the first model may be improved and online training overheads may be reduced on the premise of meeting timeliness requirements of online training.

In some embodiments, the online training strategy may include one or more of the following information: frequency of online training, information about a sample for online training of the first model, or a training parameter of the first model. The following describes each of these pieces of information.

### Frequency of Online Training

The frequency of online training may be used to indicate a quantity of times and/or frequency of the first communications device performing online training on the first model. For example, the frequency of online training may include one or more of the following information: a quantity of execution times of online training, execution frequency of online training, a start period of online training, a quantity of iterations of single time of online training, or an interval between online training.

The online training may be performed once or a plurality of times. If the online training is performed once, the first communications device may perform online training on the first model only once. In other words, on a basis of the pre-trained first model, it is required to update the first model only once based on information from the real-world environment. If the online training is performed a plurality of times, the first communications device may perform online training on the first model a plurality of times.

In some embodiments, the execution frequency of online training may be periodic. That is, the first communications device may start online training periodically. In a case in which online training is started periodically, the execution frequency of online training may be represented by a start period of online training. A start period of online learning may be obtained by means of calculation based on capability information of the first communications device and/or the training parameter of the first model. For example, the start period of online learning may be 5, 15, 25, . . . , 70, or 75 time units.

It should be noted that the time unit in this application may be a period for performing prediction by using the first model. In an example in which the first model is a channel state information feedback model, the time unit may be a CSI-RS feedback period. The time unit may alternatively be a time-related unit such as a subframe, a frame, a millisecond, a second, a minute, or an hour.

In some embodiments, the execution frequency of online training may be determined based on update frequency of a sample for training the first model. It may be understood that the sample may be updated once each time a new sample is collected. Therefore, the update frequency of the sample may alternatively be represented by a quantity of update times of the sample. The following describes, using an example, how to determine the execution frequency of online training based on the update frequency of the sample.

In an implementation, the frequency of online training may be the same as the update frequency of the sample. That is, the online training may be performed on a sample-by-sample basis, that is, online training may be performed once new training data is obtained. In another implementation, the frequency of online training may have a multiple relationship with the update frequency of the sample. For example, the update frequency of the sample may be Q times the frequency of online training, and Q may be a positive integer. For example, Q=5. In a case in which five new samples are obtained, the first communications device may perform online training on the first model once.

It may be understood that the execution frequency of online training may alternatively be indicated by a time-related indicator. As described above, the execution frequency of online training may be represented by the start period of online training. Alternatively, the execution frequency of online training may be represented by an interval between online training.

The quantity of iterations of single time of online training may be used to indicate a maximum quantity of iterations of one time of online training. In other words, the quantity of iterations of single time of online training does not exceed the maximum quantity of iterations. More iterations indicate longer duration of one time of online training. Therefore, training efficiency of the first model may be improved by determining the quantity of iterations.

Information about a Sample for Online Training of the First Model

The information about the sample for online training of the first model includes one or more of the following information: a sample data amount for single time of online training, a method of extracting a validation set for online training, or an extraction ratio of the validation set for online training.

In some embodiments, in a case in which an amount of collected sample data is greater than or equal to the first sample threshold, the first communications device may perform online training on the first model. A specific value of the first sample threshold is not limited in this application. For example, the first sample threshold may be 10, 20, . . . , 140, or 150. Considering limited memory space and computing power, in a case in which a size of the first model is not changed, training duration is directly determined depending on the sample data amount for online training. Indication of the data amount for online training may effectively resolve a timeliness problem of online training.

The method of extracting a validation set for online training may be used to indicate how the validation set is extracted from online data during training. For example, the method of extracting a validation set for online training may include random extraction or truncation.

It should be noted that the information about the sample for online training of the first model may further include an indication of other training data. The indication of training data may be used to indicate content in various aspects related to the training data. For example, the indication of training data may include an extraction ratio of the validation set.

### Training Parameter of the First Model

The training parameter of the first model may be used to indicate a related parameter for performing online training on the first model. The training parameter of the first model includes one or more of the following: a starting parameter for training the first model, a part of the first model that is required to be trained, a part of the first model that is required to be fixed, or a learning rate of the first model.

The starting parameter for training the first model is a basis for online training of the first model. Each time of online training is performed based on the starting parameter. In some embodiments, the starting parameter for training the first model may be a model parameter obtained during previous update. For example, the starting parameter for training the first model may be a model parameter obtained after previous online training of the first model. In some embodiments, the starting parameter for training the first model may be a model parameter obtained by pre-training the first model, that is, a model parameter obtained after offline training of the first model. In this case, after the first communications device updates the parameter and performs inference, a model parameter obtained in a previous period or after previous update may be deleted.

It may be understood that if the first model is trained online a plurality of times, a starting parameter for a first time of online training may only be a model parameter obtained by pre-training the first model. Starting parameters for a second time of online training and subsequent times of online training may be model parameters obtained by pre-training, or model parameters updated during online training.

A part of the first model or the whole first model may be involved in a training process and updated. In a case in which a part of the first model is required to be trained, it is required to update a model parameter for the part of the first model that is required to be trained, and it is not required to update a model parameter for a part of the first model that is required to be fixed. For example, one or more network layers in the first model may not be required to be updated, that is, may be required to be fixed. Alternatively, one or more network layers in the first model may be required to be updated, that is, may be required to be trained. Each of one or more network layers may be indicated by a starting point and an end point of the network layer.

A manner of representing the learning rate of the first model is not limited in this application. For example, the learning rate may be directly represented by a corresponding value. Alternatively, the learning rate may be indirectly represented by one or more values. For example, the learning rate is represented by a and b. Both a and b may be positive integers, and the learning rate may be represented as follows: Learning rate=a×10^{-b}.

The training parameter of the first model may further include another parameter related to training. The another parameter may include, for example, a model detection indicator. The model detection indicator may be used to indicate a monitoring indicator for an optimal parameter in an online training process of the first model. Based on the monitoring indicator for an optimal parameter, an optimal parameter of the first model during the online training process may be determined.

The foregoing describes the online training strategy in detail. The following describes how the online training strategy is determined.

As described above, the online training strategy may be determined based on the auxiliary online training strategy. The auxiliary online training strategy may be determined based on one or more of the following information: communication environment information, a capability of the first communications device, or information about the first model.

The communication environment information may be used to describe a communication environment in which the first communications device is located. For example, the communication environment information may include signal fluctuation degree information and/or a scenario identifier.

The signal fluctuation degree may be used to indicate a degree of fluctuation, drift, variation frequency, or stability of a signal in the communication environment. In some embodiments, the signal fluctuation degree may also be referred to as a data drift degree or a degree of signal fluctuation. A data stability degree may be considered the opposite of the signal fluctuation degree. It may be understood that, when the signal fluctuation degree is large, the data stability degree is small, and when the signal fluctuation degree is small, the data stability degree is large. The following uses the signal fluctuation degree as an example for description. The data stability degree is similar, and details are not described again.

In an implementation, the information about a signal fluctuation degree may be represented by one or more of class identifiers such as a slight data drift, influence due to a specific data drift, or a severe data drift. For example, statistics on signal fluctuation distribution within a period of time may be collected to determine the signal fluctuation degree. In some embodiments, in a case in which the signal fluctuation degree is less than or equal to a first fluctuation threshold, the information about the signal fluctuation degree may be a slight data drift. In a case in which the signal fluctuation degree is greater than or equal to the first fluctuation threshold, the information about the signal fluctuation degree may be a data drift to a specific degree or a severe data drift. In some embodiments, in a case in which the signal fluctuation degree is less than or equal to a second fluctuation threshold, the information about the signal fluctuation degree may be a slight data drift. In a case in which the signal fluctuation degree is greater than or equal to the second fluctuation threshold, and the fluctuation degree is less than or equal to a third fluctuation threshold, the information about the signal fluctuation degree may be a data drift to a specific degree. In a case in which the signal fluctuation degree is greater than or equal to the third fluctuation threshold, the information about the signal fluctuation degree may be a severe data drift.

The scenario identifier may be used to indicate a scenario in which the first communications device is located. For example, the scenario identifier may be used to indicate whether the first communications device is in a high-speed motion state, that is, the scenario identifier may include a high-speed scenario or a low-speed scenario. Alternatively, the scenario identifier may be used to indicate whether the first communications device is on a high-speed railway (high-speed railway), that is, the scenario identifier may include a high-speed railway scenario or a non-high-speed railway scenario.

It should be noted that the communication environment information may be independently determined by the first communications device, or may be determined by the second communications device, and then transmitted to the first communications device. The second communications device may transmit corresponding indication information to the first communications device, to notify the first communications device whether the first communications device can independently determine information about the communication environment, and/or information about the communication environment that is detected by the second communications device.

In an implementation, based on the communication environment information, frequency of online training may be determined.

In some embodiments, the frequency of online training may include a quantity of execution times of online training, and the information about the communication environment may include a signal fluctuation degree in the communication environment. The quantity of execution times may meet: in a case in which the signal fluctuation degree is less than or equal to a first fluctuation threshold, the online training may be performed once. Alternatively, the quantity of execution times may meet: in a case in which the signal fluctuation degree is greater than or equal to a first fluctuation threshold, the online training may be performed a plurality of times.

In some embodiments, a class identifier of the communication environment may be determined based on the signal fluctuation degree. For example, if the signal fluctuation degree is less than or equal to the first fluctuation threshold, the class identifier may be set to a slight data drift. If the signal fluctuation degree is greater than or equal to the first fluctuation threshold, the class identifier may be set to a data drift to a specific degree or a severe data drift.

In a scenario with stable environmental changes, continuous online learning provides little gain, and wastes resources. In view of this application, in a case in which the signal fluctuation degree is relatively small (a slight data drift), the communications device may perform online training once, such that the first model may adapt to a real-world environment, so as to obtain a relatively accurate prediction result. Since the quantity of times of online training is reduced, resources occupied by online training are also greatly reduced.

In a scenario with drastic environmental changes, performance of one-time online learning does not remain effective for a long time. That is, performance of one-time online learning may be difficult to adapt to rapid changes of the environment, leading to an inaccurate prediction result of the first model. In this application, in a case in which the signal fluctuation degree is relatively large (a data drift to a specific degree or a severe data drift), the first model may be trained online for a plurality of times, such that the first model adapts to environmental changes, thereby improving prediction accuracy of the first model.

In an implementation, based on the communication environment information, the first communications device may determine the training parameter.

In some embodiments, the training parameter of the first model may include a starting parameter for training the first model, and the information about the communication environment includes a signal fluctuation degree in the communication environment. The starting parameter may meet one of the following: in a case in which the signal fluctuation degree is less than or equal to a second fluctuation threshold, the starting parameter is a model parameter obtained by pre-training the first model; in a case in which the signal fluctuation degree is greater than or equal to the second fluctuation threshold, and the fluctuation degree is less than or equal to a third fluctuation threshold, the starting parameter is a model parameter obtained by previous online training of the first model; or in a case in which the signal fluctuation degree is greater than or equal to the third fluctuation threshold, the starting parameter is a model parameter obtained by pre-training the first model.

In some embodiments, a class identifier of the communication environment may be determined based on the signal fluctuation degree. For example, if the signal fluctuation degree is less than or equal to the second fluctuation threshold, the class identifier may be set to a slight data drift. If the signal fluctuation degree is greater than or equal to the second fluctuation threshold and is less than or equal to the third fluctuation threshold, the class identifier may be set to a data drift to a specific degree. If the signal fluctuation degree is greater than or equal to the third fluctuation threshold, the class identifier is set to a severe data drift.

In a case in which the signal fluctuation degree is relatively small (a slight data drift), the online training may be performed only once. Therefore, the starting parameter may be a model parameter obtained by pre-training the first model. In a case in which the signal fluctuation degree is relatively large, but the fluctuation is not severe (a data drift to a specific degree), a result of the previous update may be used for online update of the first model to adapt to environmental changes. In a case in which the signal fluctuation degree is relatively large (a severe data drift), if a result of the previous online update is used as the starting parameter, information about the pre-trained first model may be lost after online update is started for a plurality of times, thereby reducing generalization of the first model. Therefore, in a case in which the signal fluctuation is drastic, the starting parameter may be a model parameter obtained by pre-training the first model, thereby improving generalization of the model.

It should be noted that the second fluctuation threshold may be the same as or different from the first fluctuation threshold. Alternatively, the third fluctuation threshold may be the same as or different from the first fluctuation threshold.

The capability of the first communications device may be used to indicate a capability of the first communications device to perform online training on the first model. For example, the capability of the first communications device may be determined based on memory and/or computing power of the first communications device. The computing power may be determined based on floating-point operations of the first model.

In an implementation, the capability of the first communications device may be determined based on a quantity N of times that the first communications device may perform online update on the first model in a first period. N may be a positive integer. The first period may include one or more time units. Alternatively, the first period may be a period related to a task performed by the first model. In an example in which the first model is a channel state information feedback model, the first period may be a CSI-RS period.

In some embodiments, if the capability of the first communications device is greater than or equal to a first level threshold, it may be determined that the capability of the first communications device is relatively strong. If the capability of the first communications device is less than a first level threshold, it may be determined that the capability of the first communications device is relatively weak. For example, if N is greater than or equal to the first level threshold T, the capability of the first communications device is relatively strong. If N is less than the first level threshold T, the capability of the first communications device is relatively weak. T may be a positive integer. For example, T may be 5, 10, 15, or the like.

The capability of the first communications device may be used to determine frequency of online training. For example, the frequency of online training includes execution frequency of online training, and the execution frequency meets one of the following: in a case in which the capability of the first communications device is less than or equal to a first level threshold, the execution frequency is periodic; or in a case in which the capability of the first communications device is greater than or equal to a first level threshold, the execution frequency is determined based on update frequency of a sample.

In a case in which the capability of the first communications device is relatively strong, the execution frequency of online training may be determined based on update frequency of a sample. For example, online training may be performed on a sample-by-sample basis. That is, the first communications device may perform online learning based on a latest sample, and the updated parameter may be directly used for inference of a current sample. The execution frequency of online training is determined based on update frequency of a sample, and online training may be performed based on a new sample in a timely manner, so that the first model may quickly respond to a change in a real communication environment.

In a case in which the capability of the first communications device is relatively weak, the execution frequency of online training may be periodic. In other words, there may be one online learning period between two times of online learning performed by the first communications device. The first communications device may better use a resource for the first communications device according to an online learning period, so as to prevent online learning from occupying too many resources to cause waste of resources.

In some embodiments, the second communications device may evaluate, based on the capability of the first communication device, whether the first communications device meets a minimum capability requirement for training and/or inference of the first model. If yes, the second communications device may deploy the pre-trained first model for the first communications device.

The information about the first model includes one or more of the following information about the first model: a scale level, a model size, or supported computing power. The supported computing power may include, for example, minimum computing power supported by the first model. The online training strategy determined based on the information about the first model is targeted to the first model, so that targeted online training of the first model may be implemented.

For ease of understanding, this application describes, by using the example shown in Table 1, a method for determining the online learning strategy.

TABLE 1

| Auxiliary | Communication | Slight data | Data drift to a specific | | Severe data drift | |
|---|---|---|---|---|---|---|
| online | environment | drift | degree | | | |
| learning | information | | | | | |
| strategy | Capability of the | Meets a | Meets a | Strong | Meets a | Strong |
| | first | requirement | requirement | | requirement | |
| | communications | | | | | |
| | device | | | | | |
| Online | Starting | Parameter | Parameter obtained after | | Parameter obtained by | |
| learning | parameter for | obtained by | previous update | | pre-training a model | |
| strategy | online training | pre-training | | | | |
| | | a model | | | | |
| | Frequency of | One time of | Periodic | Update | Periodic | Update |
| | online training | update | update | on a | update | on a |
| | | | | sample- | | sample- |
| | | | | by- | | by- |
| | | | | sample | | sample |
| | | | | basis | | basis |
| | Training | Collected | Start period | Quantity | Start period | Quantity |
| | parameter | sample | of online | [0:75:5] | of online | [0:75:5] |
| | | amount | learning | of | learning | of |
| | | [0:150:10] | [0:75:5] | iterations | [0:75:5] | iterations |
| | | [0, 10, . . . , | | of a | | of a |
| | | 150] | | model | | model |
| | | | | parameter | | parameter |

It may be seen from the third column in Table 1 that if the information about the communication environment is a slight data drift and the capability of the first communications device meets a training requirement of the first model, the starting parameter for online training is a model parameter corresponding to the pre-trained first model, the online training is performed once, and a sample size for the online training this time may be [0:150:10]. It may be seen from the fourth column that if the information about the communication environment is a data drift to a specific degree and the capability of the first communications device meets a training requirement of the first model, the starting parameter for online training is a model parameter obtained during previous online training of the first model, online training is performed on a basis of periodic update, and a start period of online learning may be [0:75:5]. It may be seen from the fifth column that if the information about the communication environment is a data drift to a specific degree and the capability of the first communications device is relatively strong, the starting parameter for online training is a model parameter obtained during previous online training of the first model, online training is performed on a sample-by-sample update basis, and a quantity of iterations of online learning may be [0:75:5].

This application does not limit how the first indication information indicates the online learning strategy or the auxiliary online learning strategy. For example, a specific configuration form of the first indication information may be a summarized level indicator or a statistical numerical result. For example, the second communications device may collect online statistics on a proportion of data in historical distribution within a latest period of time, and use the proportion as content of the first indication information to be transmitted. Alternatively, statistical values may be classified into different ranges according to thresholds, to form different level indicators, and the level indicators are used as content of the first indication information to be transmitted.

In some embodiments, the first indication information may be carried in one or more of the following messages: radio resource control (RRC) signalling, a MAC CE, DCI, or uplink control information (UCI). Signalling in which the first indication information is carried may include a first indicator field, so as to directly indicate the online training strategy. In other words, the first indicator field may include the online training strategy. Therefore, the first indicator field may also be referred to as an online-learning strategies indicator configuration (OSIC) field.

In some embodiments, the first indicator field may include one bit (bit) for indicating the starting parameter for training the first model. For example, {0} may indicate that the starting parameter is a model parameter obtained after previous update, and {1} may indicate that the starting parameter is a model parameter determined during pre-training.

In some embodiments, the first indicator field may include two bits for indicating the frequency of online training. For example, {00} may indicate that the online training is performed only once. {01} may indicate that an online learning process is performed periodically. {10} may indicate that an online learning process is performed on a sample-by-sample basis.

In some embodiments, the first indicator field may include four bits related to the training parameter. The training parameter may include, for example, a data amount for single time of training, a quantity of iterations, and an interval between training.

This application does not limit an indication method of the four bits. For example, the four bits may be used to indicate a first value of the training parameter. A corresponding training parameter may be obtained by multiplying the first value by a scaling factor (factor for short). The factor may be a positive integer, for example, the factor may be a value such as 5, 10, or 15. For example, the four bits are {0011}. {0011} is converted to a decimal number of 3. If the factor is 10, a corresponding training parameter is 10×3=30. Correspondingly, an operational relationship between the training parameter M, the scaling factor α, and the first value I may be represented by using a formula

$$I = bin ( floor ( \frac{M}{α} ) ) ,$$

floor( ) indicates a floor operation, and bin( ) indicates converting to a binary number. Alternatively, in a case in which the four bits are special values (for example, {0000}), it may be indicate that a corresponding training parameter may be independently determined by the first communications device, and the second communications device does not indicate the training parameter.

For example, the training parameter is an interval between training. M may represent a quantity of CSI-RS reporting periods between two times of online training. The quantity of iterations is represented by K, and K may be a positive integer. For example, K may be 5, 10, 25, or the like. For example, K=25. A minimum quantity P of CSI-RS reporting periods required for K=25 iterations is calculated. For example, P=13, and the scaling factor is 4. If the interval between training for online learning is bin(floor(13/4))={0011}, the four bits may be written as {0011}.

For example, the training parameter M is a quantity of iterations of single time of online training, and M may meet M=N−T. N indicates a quantity of times that the first communications device may perform online update on the first model in the first period, and T indicates a first level threshold. Both N and T may be positive integers. The first period may be a CSI-RS reporting period. The first value I may be meet

$$I = bin ( floor ( \frac{N - T}{α} ) ) .$$

For example, N=24, T=5, and the scaling factor is 5. The first value may be bin(floor((24−5)/5))={0100}, that is, the four bits may be {0100}.

Signalling in which the first indication information is carried may include a second indicator field, so as to indirectly indicate the online training strategy. In other words, the second indicator field may include an auxiliary online training strategy (that is, first information). Therefore, the second indicator field may also be referred to as an aided online-learning strategies indicator configuration (aided online-learning strategies indicator configuration, AOSIC) field.

In some embodiments, the AOSIC field may include two bits for indicating communication environment information. For example, {00} may indicate that an environment condition is independently determined by the first communications device. {01} may indicate a slight data drift. {10} may indicate a data drift to a specific degree. {11} may indicate a severe data drift.

For ease of understanding, the following describes in detail, with reference to Embodiment 1 to Embodiment 3, the method provided in this application.

### Embodiment 1

Embodiment 1 is described by using an example in which the first model is a channel state feedback AI model shown in FIG. 3. Original CSI data may be obtained on a terminal device side. Therefore, an online training process may be performed on the terminal device side. Alternatively, the online training process may be performed on a network device. With reference to FIG. 7, the following description is provided by using an example in which a training process is performed on a terminal device side.

FIG. 7 is a schematic structural diagram of a method for communication according to Embodiment 1. The method shown in FIG. 7 may be performed by a terminal device and a network device. The method shown in FIG. 7 may include steps S710 to S750.

In step S710, the terminal device transmits capability information of the terminal device to the network device.

The capability information may include information such as memory and computing power of the terminal device. A unit of memory may be M, and a unit of computing power may be flops/second.

The network device may evaluate, based on the capability information, whether the terminal device meets a minimum capability requirement for training and/or inference of a first model. If the terminal device meets the minimum capability requirement, step S720 may be performed.

In step S720, the network device transmits a pre-trained first model to the terminal device, and deploys the first model on the terminal device.

As shown in FIG. 3, the first model may include an encoder and a decoder. The encoder and the decoder may be deployed on the terminal device and the network device, respectively. The encoder and the decoder are required to be jointly trained during online training. Therefore, in step S720, the terminal device is also deployed with a decoder the same as the decoder on the network device side.

After the terminal device completes initial deployment of the first model, the encoder may start to perform a CSI compression task, and the terminal device may wait for an online update indication issued by the network device.

In S730, the network device transmits first indication information to the terminal device.

The first indication information may be carried in RRC signalling, a MAC CE, DCI, or other signalling.

In a case in which the first indication information includes an online training strategy, the online training strategy may be included in a corresponding indicator field. For example, an online learning strategy may be included in an OSIC field.

In a case in which the first indication information includes an auxiliary online training strategy, the auxiliary online training strategy may be included in a corresponding indicator field. For example, an auxiliary online learning strategy may be included in an AOSIC field.

The following describes the first indication information by using each of the OSIC field and the AOSIC field as an example.

In an implementation, the OSIC field may occupy seven bits. The following describes content of each of the seven bits.

A first bit may be used to indicate a starting parameter for training the first model, that is, a starting point for online update. For example, {0} may be used to indicate that a starting parameter for online update is a model parameter obtained after previous update of the first model. {1} may be used to indicate that the starting parameter for online update is a model parameter obtained by pre-training the first model.

The network device may determine a class identifier of the communication environment based on a stability situation of the communication environment in which the terminal device is located. For example, the network device may collect statistics on signal fluctuation distribution within a historical period of time, and classify, according to a fluctuation distribution situation, the communication environment into several scenarios with a slight data drift, a data drift to a specific degree, and a severe data drift. When the class identifier of the communication environment is a slight data drift, a model parameter obtained by pre-training the first model may be used as a starting point for online update, that is, a first bit may be {1}. When the class identifier of the communication environment is a data drift to a specific degree, a model parameter obtained after previous online update may be used as a starting point for online update, that is, a first bit may be {0}. When the class identifier of the communication environment is a severe data drift, a model parameter obtained by pre-training the first model may be used as a starting point for online update, that is, a first bit may be {1}.

A second bit and a third bit may be used to indicate frequency of online training. For example, {00} may be used to indicate that the terminal device is required to perform online training only once. {01} may be used to indicate that the terminal device is required to perform an online training process periodically. {10} may be used to indicate that the terminal device is required to perform an online learning process on a sample-by-sample basis.

When the class identifier of the communication environment is a slight data drift, the first model may be required to be updated online only once. Then, the second bit and the third bit may be {00}. In a case in which the capability of the terminal device is relatively weak, the first model may be updated periodically, and the second bit and the third bit may be {01}. In a case in which the capability of the terminal device is relatively strong, the first model may be updated on a sample-by-sample basis, and the second bit and the third bit may be {10}.

A fourth bit to a seventh bit may be used to indicate a parameter for online training. For example, in a case in which the first model requires only one time of online training, the fourth bit to the seventh bit may be used to indicate an amount of data required for the only one time of online training. For example, in a case in which the capability of the terminal device is relatively strong, the fourth bit to the seventh bit may be used to indicate a quantity of iterations of single time of online update. For example, in a case in which the capability of the terminal device is relatively weak, the fourth bit to the seventh bit may be used to indicate a quantity of CSI-RS reporting periods between two times of online training.

The OSIC field is described above. The AOSIC field is described below. The AOSIC field may occupy two bits. The two bits may be used to indicate a fluctuation situation of the communication environment. For example, {00} may be used to indicate that a situation of the communication environment is independently determined by the terminal device. {01} may be used to indicate a slight data drift. {10} may be used to indicate a data drift to a specific degree. {11} may be used to indicate a severe data drift.

In steps S741 to S749, the terminal device performs CSI-RS reception for a plurality of times, and determines an inference result of the decoder based on the first model.

In a process of performing steps S741 to S749, the terminal device may perform step S750. In step S750, the terminal device performs online training on the first model once or a plurality of times based on the online training strategy.

In some embodiments, the terminal device may parse the OSIC field, so as to directly obtain the online training strategy, and further perform online training on the first model according to indication of the online training strategy. In some embodiments, the terminal device may parse the AOSIC field, and further independently determine the online training strategy according to a parsing result, so as to perform online training on the first model according to indication of the online training strategy.

In an implementation, the terminal device may parse the auxiliary online training strategy. Based on a parsing result, the terminal device determines a specific online training strategy. For example, the online training strategy determined by the terminal device may include: {01}, which indicates that the terminal device is required to perform online update only once; {10}, which indicates that the terminal device is required to perform update periodically, where an initial parameter for online update is a model parameter obtained after previous update; and {11}, which indicates that the terminal device is required to perform update periodically, where an initial parameter for online update is always a model parameter obtained by pre-training the model.

### Embodiment 2

Embodiment 2 is described by using an example in which the first model is an AI model used for beam management.

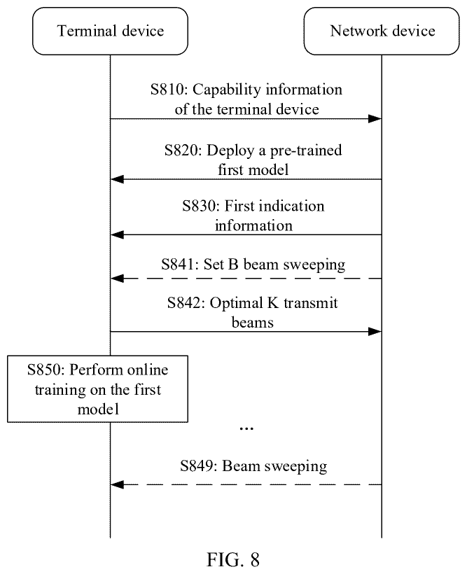

FIG. 8 is a schematic structural diagram of a method for communication according to Embodiment 2. The method shown in FIG. 8 may be executed by a terminal device and a network device. The method shown in FIG. 8 may include steps S810 to S850.

In step S810, the terminal device transmits capability information of the terminal device to the network device.

The network device may evaluate, based on the capability information, whether the terminal device meets a minimum capability requirement for training and/or inference of a first model. If the terminal device meets the minimum capability requirement, step S820 may be performed.

In step S820, the network device transmits a pre-trained first model to the terminal device, and deploys the first model on the terminal device.

In step S830, the network device transmits first indication information to the terminal device.

The first indication information may include an online training strategy, or may include an auxiliary online training strategy.

In steps S841 to S849, the terminal device performs set B beam sweeping for a plurality of times, and determines corresponding optimal K transmit beams.

In a process of performing steps S841 to S849, the terminal device may perform step S850. In step S850, the terminal device performs online training on the first model once or a plurality of times based on the online training strategy.

Embodiment 2 includes some steps similar to those in Embodiment 1. For parts not described in detail in Embodiment 2, reference may be made to Embodiment 1.

### Embodiment 3

Embodiment 3 is described by using an example in which the first model is an AI model used for beam management.

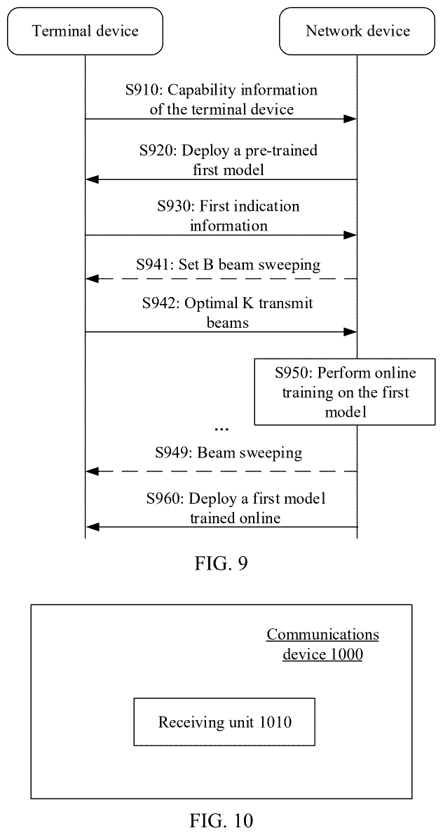

FIG. 9 is a schematic structural diagram of a method for communication according to Embodiment 3. The method shown in FIG. 9 may be executed by a terminal device and a network device. The method shown in FIG. 9 may include steps S910 to S960.

In step S910, the terminal device transmits capability information of the terminal device to the network device.

The network device may evaluate, based on the capability information, whether the terminal device meets a minimum capability requirement for training and/or inference of a first model. If the terminal device meets the minimum capability requirement, step S920 may be performed.

In step S920, the network device transmits a pre-trained first model to the terminal device, and deploys the first model on the terminal device.

The terminal device may perform a beam prediction task based on the first model. Triggering of online update of the first model may be implemented based on an activation indication issued by the network device. Alternatively, the terminal device may actively trigger online update of the first model.

In step S930, the network device receives first indication information transmitted by the terminal device.

The first indication information may be carried in UCI signalling. The first indication information may include an online training strategy, or may include an auxiliary online training strategy. The following description is provided by using an example in which the first indication information includes an auxiliary online training strategy.

The auxiliary online training strategy may be indicated by using an AOSIC field. For example, the AOSIC field may occupy two bits. The two bits may be used to indicate a fluctuation situation of the communication environment. For example, {00} may be used to indicate that a situation of the communication environment is independently determined by the network device. {01} may be used to indicate a slight data drift. {10} may be used to indicate a data drift to a specific degree. {11} may be used to indicate a severe data drift.

Based on the auxiliary online training strategy, the network device may determine the online training strategy.

In an implementation, the network device may parse the auxiliary online training strategy. Based on a parsing result, the network device may determine a specific online training strategy. For example, the online training strategy may include: {01}, which indicates that the network device is required to perform online update only once; {10}, which indicates that the network device is required to perform update periodically, where an initial parameter for online update is a model parameter obtained after previous update; and {11}, which indicates that the network device is required to perform update periodically, where an initial parameter for online update is always a model parameter obtained by pre-training the model.

In steps S941 to S949, the terminal device performs set B beam sweeping for a plurality of times, and determines corresponding optimal K transmit beams.

In a process of performing steps S941 to S949, the network device may perform step S950. In step S950, the network device performs online training on the first model once or a plurality of times based on the online training strategy.

In step S960, the network device transmits the first model subjected to online training to the terminal device and deploys the first model on the terminal device.

Embodiment 3 includes some steps similar to those in Embodiment 1. For parts not described in detail in Embodiment 3, reference may be made to Embodiment 1.

Embodiments 1 to 3 respectively describe application of the method provided in this application to the channel state information feedback model and/or the beam management model. It should be noted that the method provided in this application may be further applied to another model on which online training is required to be performed, which is not limited in this application.

The method embodiments of this application are described in detail above. Apparatus embodiments of this application are described below in detail with reference to FIG. 10 to FIG. 12. It should be understood that the description of the method embodiments corresponds to the description of the apparatus embodiments, and therefore, for parts that are not described in detail, reference may be made to the foregoing method embodiments.

FIG. 10 is a schematic structural diagram of a communications device 1000 according to an embodiment of this application. The communications device 1000 may be a first communications device. The communications device 1000 may include a receiving unit 1010.

The receiving unit 1010 is configured to receive first indication information, where the first communications device performs, based on the first indication information, online training on a first model used for communication, where the first indication information is used to indicate an online training strategy for the first model.

In some embodiments, the online training strategy includes one or more of the following information: frequency of online training, information about a sample for online training of the first model, or a training parameter of the first model.

In some embodiments, the frequency of online training may include one or more of the following information: a quantity of execution times of online training, execution frequency of online training, a start period of online training, a quantity of iterations of single time of online training, or an interval between online training.

In some embodiments, the information about the sample for online training of the first model includes one or more of the following information: a sample data amount for single time of online training, a method of extracting a validation set for online training, or an extraction ratio of the validation set.

In some embodiments, the training parameter of the first model includes one or more of the following: a starting parameter for training the first model, a part of the first model that is required to be trained, a part of the first model that is required to be fixed, or a learning rate of the first model.

In some embodiments, the online training strategy is determined based on first information, and the first information includes one or more of the following information: communication environment information, a capability of the first communications device, or information about the first model.

In some embodiments, the communication environment information includes data fluctuation degree information and/or a scenario identifier.

In some embodiments, the capability of the first communications device is determined based on memory and/or computing power of the first communications device.

In some embodiments, the information about the first model includes one or more of the following information about the first model: a scale level, a model size, or supported computing power.

In some embodiments, the first information is included in the first indication information.

In some embodiments, the online training strategy includes frequency of online training, and the frequency of online training is determined based on a capability of the first communications device and/or information about a communication environment.

In some embodiments, the frequency of online training includes execution frequency of online training, and the execution frequency meets one of the following: in a case in which the capability of the first communications device is less than or equal to a first level threshold, the execution frequency is periodic; or in a case in which the capability of the first communications device is greater than or equal to a first level threshold, the execution frequency is determined based on update frequency of a sample.

In some embodiments, the frequency of online training includes a quantity of execution times of online training, the information about the communication environment includes a signal fluctuation degree in the communication environment, and the quantity of execution times meets one of the following: in a case in which the signal fluctuation degree is less than or equal to a first fluctuation threshold, the online training is performed once; or in a case in which the signal fluctuation degree is greater than or equal to a first fluctuation threshold, the online training is performed a plurality of times.

In some embodiments, the online training strategy includes a training parameter of the first model, and the training parameter of the first model is determined based on information about a communication environment.

In some embodiments, the training parameter of the first model includes a starting parameter for training the first model, the information about the communication environment includes a signal fluctuation degree in the communication environment, and the starting parameter meets one of the following:

In some embodiments, the starting parameter is a model parameter obtained by pre-training the first model; in a case in which the signal fluctuation degree is greater than or equal to the second fluctuation threshold, and the fluctuation degree is less than or equal to a third fluctuation threshold, the starting parameter is a model parameter obtained by previous online training of the first model; or in a case in which the signal fluctuation degree is greater than or equal to the third fluctuation threshold, the starting parameter is a model parameter obtained by pre-training the first model.

In some embodiments, the first indication information is carried in one or more of the following messages: RRC signalling, a MAC CE, DCI, or UCI.

In some embodiments, the first model includes a channel state information feedback model and/or a beam management model.

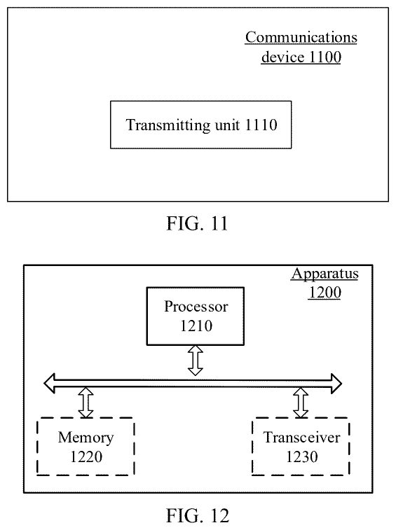

FIG. 11 is a schematic structural diagram of a communications device 1100 according to an embodiment of this application. The communications device 1100 may be a second communications device. The communications device 1100 may include a transmitting unit 1110.

The transmitting unit 1110 is configured to transmit first indication information to a first communications device, where the first indication information is used to indicate an online training strategy for an artificial intelligence first model used for communication, and the first model is trained online based on the first indication information.

In some embodiments, the online training strategy includes one or more of the following information: frequency of online training, information about a sample for online training of the first model, or a training parameter of the first model.

In some embodiments, the frequency of online training may include one or more of the following information: a quantity of execution times of online training, execution frequency of online training, a start period of online training, a quantity of iterations of single time of online training, or an interval between online training.

In some embodiments, the information about the sample for online training of the first model includes one or more of the following information: a sample data amount for single time of online training, a method of extracting a validation set for online training, or an extraction ratio of the validation set.

In some embodiments, the training parameter of the first model includes one or more of the following: a starting parameter for training the first model, a part of the first model that is required to be trained, a part of the first model that is required to be fixed, or a learning rate of the first model.

In some embodiments, the online training strategy is determined based on first information, and the first information includes one or more of the following information: communication environment information, a capability of the first communications device, or information about the first model.

In some embodiments, the communication environment information includes data fluctuation degree information and/or a scenario identifier.

In some embodiments, the capability of the first communications device is determined based on memory and/or computing power of the first communications device.

In some embodiments, the information about the first model includes one or more of the following information about the first model: a scale level, a model size, or supported computing power.

In some embodiments, the first information is included in the first indication information.

In some embodiments, the online training strategy includes frequency of online training, and the frequency of online training is determined based on a capability of the first communications device and/or information about a communication environment.

In some embodiments, the frequency of online training includes execution frequency of online training, and the execution frequency meets one of the following: in a case in which the capability of the first communications device is less than or equal to a first level threshold, the execution frequency is periodic; or in a case in which the capability of the first communications device is greater than or equal to a first level threshold, the execution frequency is determined based on update frequency of a sample.

In some embodiments, the frequency of online training includes a quantity of execution times of online training, the information about the communication environment includes a signal fluctuation degree in the communication environment, and the quantity of execution times meets one of the following: in a case in which the signal fluctuation degree is less than or equal to a first fluctuation threshold, the online training is performed once; or in a case in which the signal fluctuation degree is greater than or equal to a first fluctuation threshold, the online training is performed a plurality of times.

In some embodiments, the online training strategy includes a training parameter of the first model, and the training parameter of the first model is determined based on information about a communication environment.

In some embodiments, the training parameter of the first model includes a starting parameter for training the first model, the information about the communication environment includes a signal fluctuation degree in the communication environment, and the starting parameter meets one of the following: in a case in which the signal fluctuation degree is less than or equal to a second fluctuation threshold, the starting parameter is a model parameter obtained by pre-training the first model; in a case in which the signal fluctuation degree is greater than or equal to the second fluctuation threshold, and the fluctuation degree is less than or equal to a third fluctuation threshold, the starting parameter is a model parameter obtained by previous online training of the first model; or in a case in which the signal fluctuation degree is greater than or equal to the third fluctuation threshold, the starting parameter is a model parameter obtained by pre-training the first model.

In some embodiments, the first indication information is carried in one or more of the following messages: RRC signalling, a MAC CE, DCI, or UCI.

In some embodiments, the first model includes a channel state information feedback model and/or a beam management model.

In an optional embodiment, the receiving unit 1010 or the transmitting unit 1110 may be a transceiver 1230. The communications device 1000 or the communications device 1010 may further include a processor 1210 or a memory 1220, as shown in FIG. 12.

FIG. 12 is a schematic structural diagram of an apparatus for communication according to an embodiment of this application. Dashed lines in FIG. 12 indicate that the unit or module is optional. The apparatus 1200 may be configured to implement the method described in the foregoing method embodiments. The apparatus 1200 may be a chip, a terminal device, or a network device.

The apparatus 1200 may include one or more processors 1210. The processor 1210 may support the apparatus 1200 to implement the method described in the foregoing method embodiments. The processor 1210 may be a general-purpose processor or a dedicated processor. For example, the processor may be a central processing unit (CPU). Alternatively, the processor may be another general-purpose processor, a digital signal processor (DSP), an application-specific integrated circuit (ASIC), a field programmable gate array (FPGA) or another programmable logic device, a discrete gate or transistor logic device, a discrete hardware component, or the like. The general-purpose processor may be a microprocessor, or the processor may be any conventional processor or the like.

The apparatus 1200 may further include one or more memories 1220. The memory 1220 stores a program, and the program may be executed by the processor 1210, so that the processor 1210 executes the method described in the foregoing method embodiments. The memory 1220 may be separate from the processor 1210 or may be integrated into the processor 1210.

The apparatus 1200 may further include a transceiver 1230. The processor 1210 may communicate with another device or chip by using the transceiver 1230. For example, the processor 1210 may transmit data to and receive data from the another device or chip through the transceiver 1230.

An embodiment of this application further provides a computer-readable storage medium, configured to store a program. The computer-readable storage medium may be applied to the terminal or the network device provided in the embodiments of this application, and the program causes the computer to execute the method executed by the terminal or the network device in the embodiments of this application.

An embodiment of this application further provides a computer program product. The computer program product includes a program. The computer program product may be applied to the terminal or the network device provided in the embodiments of this application, and the program causes the computer to execute the method executed by the terminal or the network device in the embodiments of this application.

An embodiment of this application further provides a computer program. The computer program may be applied to the terminal or the network device provided in the embodiments of this application, and the computer program enables a computer to execute the method executed by the terminal or the network device in the embodiments of this application.

It should be understood that the terms “system” and “network” in this application may be used interchangeably. In addition, the terms used in this application are merely used to explain specific embodiments of this application, and are not intended to limit this application. The terms “first”, “second”, “third”, “fourth”, and the like in the specification, claims, and drawings of this application are used to distinguish between different objects, rather than to describe a specific order. In addition, the terms “include” and “have” and any variations thereof are intended to cover a non-exclusive inclusion.

In embodiments of this application, “indication” mentioned herein may refer to a direct indication, or may refer to an indirect indication, or may mean that there is an association relationship. For example, A indicates B, which may mean that A directly indicates B, for example, B may be obtained by means of A; or may mean that A indirectly indicates B, for example, A indicates C, and B may be obtained by means of C; or may mean that there is an association relationship between A and B.

In embodiments of this application, “B corresponding to A” means that B is associated with A, and B may be determined based on A. However, it should be further understood that determining B according to A does not mean determining B according to A only, and may further determine B according to A and/or other information.

In embodiments of this application, the term “correspond” may mean that there is a direct or indirect correspondence between the two, or may mean that there is an association relationship between the two, or may mean that there is a relationship such as indicating and being indicated, or configuring and being configured.

In embodiments of this application, “predefined” or “pre-configured” may be implemented by pre-storing corresponding code, tables, or other forms that may be used to indicate related information in devices (for example, including a terminal device and a network device), and a specific implementation thereof is not limited in this application. For example, predefined may indicate being defined in a protocol.

In embodiments of this application, the “protocol” may indicate a standard protocol in the communications field, which may include, for example, an LTE protocol, an NR protocol, and a related protocol applied to a future communications system. This is not limited in this application.

In embodiments of this application, the term “and/or” is merely an association relationship that describes associated objects, and represents that there may be three relationships. For example, A and/or B may represent three cases: only A exists, both A and B exist, and only B exists. In addition, the character “/” in the specification generally indicates an “or” relationship between the associated objects.

In the embodiments of this application, sequence numbers of the foregoing processes do not mean execution sequences. The execution sequences of the processes should be determined according to functions and internal logic of the processes, and should not be construed as any limitation on the implementation processes of the embodiments of this application.

In several embodiments provided in this application, it should be understood that the disclosed system, apparatus, and method may be implemented in another manner. For example, the described apparatus embodiments are merely examples. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented as indirect couplings or communication connections through some interfaces, apparatus or units, and may be implemented in electronic, mechanical, or other forms.

The units described as separate parts may or may not be physically separate, and parts displayed as units may or may not be physical units, and may be located in one position, or may be distributed on a plurality of network units. Some or all of the units may be selected according to actual needs to achieve the objective of the solutions of embodiments.

In addition, functional units in embodiments of this application may be integrated into one processing unit, or each of the units may exist alone physically, or two or more units may be integrated into one unit.

All or some of the foregoing embodiments may be implemented by using software, hardware, firmware, or any combination thereof. When software is used to implement embodiments, the foregoing embodiments may be implemented completely or partially in a form of a computer program product. The computer program product includes one or more computer instructions. When the computer program instructions are loaded and executed on a computer, the procedures or functions according to embodiments of this application are completely or partially generated. The computer may be a general-purpose computer, a dedicated computer, a computer network, or another programmable apparatus. The computer instructions may be stored in a computer-readable storage medium or transmitted from one computer-readable storage medium to another computer-readable storage medium. For example, the computer instructions may be transmitted from a website, computer, server, or data center to another website, computer, server, or data center in a wired (for example, a coaxial cable, an optical fiber, and a digital subscriber line (DSL)) manner or a wireless (for example, infrared, wireless, and microwave) manner. The computer-readable storage medium may be any usable medium readable by the computer, or a data storage device, such as a server or a data center, integrating one or more usable media. The usable medium may be a magnetic medium (for example, a floppy disk, a hard disk, or a magnetic tape), an optical medium (for example, a digital video disc (digital video disc, DVD)), a semiconductor medium (for example, a solid state drive (SSD)), or the like.

The foregoing descriptions are merely specific implementations of this application, but the protection scope of this application is not limited thereto. Any variation or replacement readily figured out by a person skilled in the art within the technical scope disclosed in this application shall fall within the protection scope of this application. Therefore, the protection scope of this application shall be subject to the protection scope of the claims.

What is claimed is:

1. A method for communication, comprising:
transmitting, by a second communications device, first indication information to a first communications device,
wherein the first indication information is used to indicate an online training strategy for an artificial intelligence first model used for communication, and the first model is trained online based on the first indication information.

2. The method according to claim 1, wherein the online training strategy comprises one or more of following information:
frequency of online training, information about a sample for online training of the first model, or a training parameter of the first model.

3. The method according to claim 2, wherein the frequency of online training comprises one or more of following information:
a quantity of execution times of online training, execution frequency of online training, a start period of online training, a quantity of iterations of single time of online training, or an interval between online training.

4. A communications device, wherein the communications device is a first communications device, the first communications device comprises a memory and a processor, the memory is configured to store a computer program, and the processor is configured to execute the computer program stored in the memory to cause the first communications device to perform operations comprising:
receiving first indication information; and
performing, based on the first indication information, online training on a first model used for communication,
wherein the first indication information is used to indicate an online training strategy for the first model.

5. The communications device according to claim 4, wherein the online training strategy comprises one or more of following information:
frequency of online training, information about a sample for online training of the first model, or a training parameter of the first model.

6. The communications device according to claim 5, wherein the frequency of online training comprises one or more of following information:
a quantity of execution times of online training, execution frequency of online training, a start period of online training, a quantity of iterations of single time of online training, or an interval between online training.

7. The communications device according to claim 5, wherein the information about the sample for online training of the first model comprises one or more of following information:
a sample data amount for single time of online training, a method of extracting a validation set for online training, or an extraction ratio of the validation set.

8. The communications device according to claim 5, wherein the training parameter of the first model comprises one or more of following:
a starting parameter for training the first model, a part of the first model that is required to be trained, a part of the first model that is required to be fixed, or a learning rate of the first model.

9. The communications device according to claim 4, wherein the online training strategy is determined based on first information, and the first information comprises one or more of following information: communication environment information, a capability of the first communications device, or information about the first model;
wherein the communication environment information comprises data fluctuation degree information and/or a scenario identifier.

10. The communications device according to claim 9, wherein the capability of the first communications device is determined based on memory and computing power of the first communications device.

11. The communications device according to claim 9, wherein the information about the first model comprises one or more of following information about the first model: a scale level, a model size, or supported computing power.

12. The communications device according to claim 9, wherein the first information is comprised in the first indication information.

13. The communications device according to claim 4, wherein the online training strategy comprises frequency of online training, and the frequency of online training is determined based on a capability of the first communications device and/or information about a communication environment.

14. The communications device according to claim 13, wherein the frequency of online training comprises execution frequency of online training, and the execution frequency meets one of following:
in a case in which the capability of the first communications device is less than or equal to a first level threshold, the execution frequency is periodic; or
in a case in which the capability of the first communications device is greater than or equal to a first level threshold, the execution frequency is determined based on update frequency of a sample.

15. The communications device according to claim 13, wherein the frequency of online training comprises a quantity of execution times of online training, the information about the communication environment comprises a signal fluctuation degree in the communication environment, and the quantity of execution times meets one of following:
in a case in which the signal fluctuation degree is less than or equal to a first fluctuation threshold, the online training is performed once; or
in a case in which the signal fluctuation degree is greater than or equal to a first fluctuation threshold, the online training is performed a plurality of times.

16. The communications device according to claim 4, wherein the online training strategy comprises a training parameter of the first model, and the training parameter of the first model is determined based on information about a communication environment;
wherein the training parameter of the first model comprises a starting parameter for training the first model, the information about the communication environment comprises a signal fluctuation degree in the communication environment, and the starting parameter meets one of following:
in a case in which the signal fluctuation degree is less than or equal to a second fluctuation threshold, the starting parameter is a model parameter obtained by pre-training the first model;
in a case in which the signal fluctuation degree is greater than or equal to the second fluctuation threshold, and the fluctuation degree is less than or equal to a third fluctuation threshold, the starting parameter is a model parameter obtained by previous online training of the first model; or
in a case in which the signal fluctuation degree is greater than or equal to the third fluctuation threshold, the starting parameter is a model parameter obtained by pre-training the first model.

17. The communications device according to claim 4, wherein the first indication information is carried in one or more of following messages: radio resource control RRC signalling, a medium access control control element MAC CE, downlink control information DCI, or uplink control information UCI;
wherein the first model comprises a channel state information feedback model and/or a beam management model.

18. A communications device, wherein the communications device is a second communications device, the second communications device comprises a memory and a processor, the memory is configured to store a computer program, and the processor is configured to execute the computer program stored in the memory to cause the second communications device to perform an operation of:
transmitting first indication information to a first communications device,
wherein the first indication information is used to indicate an online training strategy for an artificial intelligence first model used for communication, and the first model is trained online based on the first indication information.

19. The communications device according to claim 18, wherein the online training strategy comprises one or more of following information:
frequency of online training, information about a sample for online training of the first model, or a training parameter of the first model.

20. The communications device according to claim 19, wherein the frequency of online training comprises one or more of following information:
a quantity of execution times of online training, execution frequency of online training, a start period of online training, a quantity of iterations of single time of online training, or an interval between online training.
